(19) United States
(12) Patent Application Publication
(10) Pub. No.: US 2003/0161586 A1
(43) Pub. Date: Aug. 28, 2003

(54) Ferrule, a fabrication method therefor and an optical connector plug

(76) Inventor: Ken Hirabayashi, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/339,075

(22) Filed: Jan. 9, 2003

(30) Foreign Application Priority Data
Jan. 16, 2002 (JP) 2002-007784

(51) Int. Cl. G02B 6/36

(52) U.S. Cl. 385/78

(57) ABSTRACT

A ferrule comprises a ferrule cylindrical body for retaining an end of an optical fiber, and a flange member including a holder portion disposed at a trailing end of the ferrule cylindrical body for retaining a core fiber including the optical fiber and a cladding over an outer periphery of the optical fiber, and a flange portion shaped like a polygon or disc circumferentially projecting as provided on an outer periphery of the holder portion and including a rotation positioning portion for defining a position of the ferrule cylindrical body relative to a holder member of an optical connector plug, and is characterized in that the flange portion consists of a plurality of split members, each comprising a circumferentially divided segment.

### BACKGROUND OF THE INVENTION

1. Field of the Invention

The present invention relates to a ferrule forming a part of a plug constituting an optical connector assembly for optical interconnection, a fabrication method for the same, and an optical connector plug.

2. Description of the Related Art

In the conventional coherent optical communications systems or photo interferometry devices such as a fiber optic gyro and the like, polarization-maintaining optical fibers capable of preserving the polarization plane of propagating light for propagation over a long distance have been used widely. There have been known various types of polarization-maintaining optical fibers, the well-known ones of which are those provided with a core portion or a stress providing portion within a cladding. For instance, PANDA polarization-maintaining optical fibers featuring great double indices of refraction and excellent polarization maintaining characteristics have been widely used.

A ferrule for receivingly retaining such a polarization-maintaining optical fiber typically comprises a ferrule cylindrical body including an optical-fiber insertion hole formed from a hard ceramic material such as zirconia or the like; and a flange member formed from a metal, such as stainless steel or the like, plastic or ceramic and including a flange portion mounted to a trailing end of the ferrule cylindrical body, having a fiber-core insertion hole for retaining an optical fiber core, and formed with a rotation positioning portion, such as a key groove or the like, used when positioning and fixing the ferrule cylindrical body to a holder member for retaining the ferrule of the optical connector. The ferrule is assembled by the steps of fitting the ferrule cylindrical body with the flange member, and then injecting an adhesive or the like into the optical-fiber insertion hole and fiber-core insertion hole for adhesively fixing the optical fiber core and polarization-maintaining optical fiber therein. Subsequently, an end face of the polarization-maintaining optical fiber and ferrule cylindrical body is polished.

The ferrule thus fabricated is assembled in the holder member of the optical connector plug for optical connection with another polarization-maintaining optical fiber or an optical device.

Such an optical connection between the polarization-maintaining optical fibers or between the polarization-maintaining optical fiber and the optical device must be based on propagation of high extinction ratio and hence, a primary polarization axis of the polarization-maintaining optical fiber is positioned with reference to the position of a rotation positioning portion provided at the flange portion. In the assembly of the ferrule, therefore, the primary polarization axis of the polarization-maintaining optical fiber and the rotation positioning portion are so positioned as to establish a predetermined positional relation therebetween and then, the optical fiber is fixed to place by means of the adhesive. When the ferrule and the optical fiber are bonded together, the rotation positioning portion of the ferrule must be positioned relative to the direction of the polarization plane of the optical fiber within an allowed axial rotation angle of ±3 degrees or less. Hence, the optical fiber is adjusted for its angular position about its axis as microscopically observing the end face of the optical fiber so that the optical fiber may be adhesively fixed to the ferrule cylindrical body in a favorable position. However, the adjustment operation is cumbersome, resulting in a time-consuming assembly work with poor assembly precisions.

As a solution to such a problem, there has been proposed a ferrule wherein a flange member comprises separate members which include a cylindrical holder portion, and an annular flange portion disposed on an outer periphery of the holder portion and having a rotation positioning portion, such as a key groove, for positioning a ferrule cylindrical body in a holder member of an optical connector plug.

According to this ferrule, the holder portion is fitted on the ferrule cylindrical body, while the optical fiber is fixed in the ferrule cylindrical body by means of an adhesive and then an end face of the ferrule cylindrical body is polished. The ferrule cylindrical body is adjusted for its angular position about the axis of the optical fiber while microscopically observing the end face thereof (or the end face of the optical fiber). Then, the flange member is secured to an outer periphery of the holder portion by means of an adhesive whereby the rotation positioning portion of the flange portion can be positioned relative to the direction of the polarization plane of the optical fiber.

On the other hand, a ferrule for oblique PC (Physical Contact) connector has been known as a ferrule directed to the reduction of connection loss and reflection return loss during the optical connection. The ferrule is arranged such that a leading end face of the optical fiber and ferrule cylindrical body retaining a leading end of the optical fiber is in the form of an obliquely projecting plane relative to a plane orthogonal to the optical fiber axis.

A fabrication method for such a ferrule for oblique PC connector generally includes the steps of inserting the optical fiber into the ferrule comprising the ferrule cylindrical body and the flange member and fixing the optical fiber therein; and polishing the leading end face of the ferrule cylindrical body and optical fiber into the obliquely projecting plane relative to the plane orthogonal to the optical fiber axis in a manner to establish a predetermined positional relation between the obliquely projecting plane and the rotation positioning portion, such as the key groove, of the flange portion.

Unfortunately, the ferrule for PC connector has the following problem. If the ferrules are significantly moved along the direction of rotation about the axes thereof when they are in end-to-end connection with their end faces abutted against each other, the same effect as that of the projecting plane increased in the curvature eccentricity results. Therefore, a low insertion loss and a high return loss cannot be attained.

In order to achieve the low insertion loss and high return loss, the curvature eccentricity of the projecting plane of the leading end face of the ferrule cylindrical body must be limited to 50 μm or less. This dictates the need to provide specifications equivalent to those for a ferrule cylindrical body having a curvature eccentricity of 50 μm or less by limiting the angle of axial rotation of the ferrule to not more than 3 degrees or preferable to not more than ±2 degrees.

In this connection, a clearance between the rotation positioning portion of the flange portion and the engagement portion formed in the holder member may be limited to the range of 0.01 to 0.1 mm thereby decreasing variations in the axial rotation of the ferrule to provide the similar specifications for the ferrule having the curvature eccentricity of 50 μm or less. Thus is achieved the low insertion loss and high return loss.

However, in the aforementioned ferrule comprising the separate members of the holder portion for retaining the polarization-maintaining optical fiber and the flange portion, the flange portion must be threaded onto the optical fiber before the flange portion introduced from the trailing end side is fitted on the holder portion and bonded thereto. This results in a cumbersome assembly work.

Where the flange portion introduced from the leading end side is fitted on the holder portion, the flange portion is more likely to cause damage on the polished leading end face of the ferrule cylindrical body and optical fiber.

Even if the rotation positioning portion of the flange portion can be positioned relative to the direction of the polarization plane of the optical fiber within the allowance of ±3 degrees, the following problem may occur when the ferrule retaining the optical fiber is retained by the optical connector plug. The axial rotational movement of the ferrule relative to the holder member may become excessive depending upon a clearance between the engagement portion formed in the holder member retaining the ferrule of the optical connector plug and the rotation positioning portion of the ferrule engaging the engagement portion of the holder member. Consequently, the propagation of high extinction ratio cannot be achieved.

However, the same approach as in the oblique PC connector may be taken to limit the clearance between the rotation positioning portion of the flange portion and the engagement portion in the holder member to the range of 0.01 to 0.1 mm, whereby the variations in the axial rotation of the ferrule can be decreased to permit the ferrule to rotate axially within a predetermined rotation angle relative to the holder member.

However, the optical connector or oblique PC connector employing the ferrule retaining the polarization-maintaining optical fiber encounters the following problem associated with the clearance between the rotation positioning portion of the flange portion and the engagement portion limited to the range of 0.01 to 0.1 mm for reducing the variations in the axial rotation of the ferrule. Because of the restricted radial movement of the ferrule, attaching/removing the optical connector plug to/from an optical connector adapter suffers low stability.

In comparison with an optical connector plug employing a ferrule cylindrical body having an outside diameter of 2.5 mm, an optical connector plug employing a ferrule cylindrical body having an outside diameter of 1.25 mm need to decrease the clearance between the rotation positioning portion of the flange portion and the engagement portion substantially to a half of that of the above ferrule in order to decrease the curvature eccentricity. This requires a high precision working, which is impracticable.

In view of the foregoing, it is an object of the invention to provide a ferrule, a fabrication method for the same and an optical connector plug contributing to the simplification of an assembly work for fabrication, facilitating the positioning and fixing of the rotation positioning portion and the definition of the clearance between the rotation positioning portion and the engagement portion, and achieving propagation of high extinction ratio while reducing connection loss and reflection return loss.

### SUMMARY OF THE INVENTION

In accordance with a first aspect of the invention for achieving the above object, a ferrule comprises: a ferrule cylindrical body for retaining an end of an optical fiber; and a flange portion shaped like a polygon or disc circumferentially projecting as provided on an outer periphery of the ferrule cylindrical body and including a rotation positioning portion for defining a position of the ferrule cylindrical body relative to a holder member of an optical connector plug,

wherein the flange portion comprises a plurality of split members each consisting of a circumferentially divided segment.

In accordance with a second aspect of the invention, a ferrule comprises: a ferrule cylindrical body for retaining an end of an optical fiber; and a flange member including a holder portion provided at a trailing end of the ferrule cylindrical body for retaining a fiber core comprising the optical fiber and a cladding over an outer periphery of the optical fiber, and a flange portion shaped like a polygon or disc circumferentially projecting as provided on an outer periphery of the ferrule cylindrical body and including a rotation positioning portion for defining a position of the ferrule cylindrical body relative to a holder member of an optical connector plug, wherein the flange portion comprises a plurality of split members each consisting of a circumferentially divided segment.

In accordance with a third aspect of the invention, the ferrule defined by the first or second aspect is characterized in that the flange portion has a disc-like shape and includes a predetermined clearance between circumferentially opposite end faces of the split members, and that the rotation positioning portion comprises a key groove defined between the circumferentially opposite end faces of the split members.

In accordance with a fourth aspect of the invention, the ferrule defined by the first or second aspect is characterized in that the rotation positioning portion comprises an outer periphery of the flange portion.

In accordance with a fifth aspect of the invention, the ferrule defined by any one of the first to fourth aspects is characterized in that a predetermined clearance is formed between an inner periphery of the split member exclusive of its circumferential ends and an outer periphery of the holder portion or the ferrule cylindrical body.

In accordance with a sixth aspect of the invention, the ferrule defined by any one of the second to fifth aspects is characterized in that the outer periphery of the holder portion comprises a first tapered surface, whereas an inside surface of the split member constituting the flange portion comprises a second tapered surface slidably contacting the first tapered surface.

In accordance with a seventh aspect of the invention, the ferrule defined by the sixth aspect is characterized in that the first tapered surface comprises the outer periphery of the holder portion progressively decreased in outside diameter toward the leading end side, whereas the second tapered surface comprises the inside surface of the split member, constituting the flange portion, progressively decreased in inside diameter toward the leading end side.

In accordance with an eighth aspect of the invention, the ferrule defined by any one of the second to fifth aspects is characterized in that the holder portion is provided with a flange on the outer periphery thereof, the flange radially projecting and engaging the flange portion for restricting an axial movement thereof.

In accordance with a ninth aspect of the invention, the ferrule defined by any one of the first to eight aspects is characterized in that the optical fiber is a polarization-maintaining optical fiber.

In accordance with a tenth aspect of the invention, the ferrule defined by any one of the first to ninth aspects is characterized in that a leading end face of the ferrule cylindrical body and optical fiber is in the form of an obliquely projecting face relative to a plane orthogonal to an axis of the optical fiber.

In accordance with an eleventh aspect of the invention, an optical connector plug comprises the ferrule defined by any one of the first to tenth aspects, and a holder member for retaining the ferrule.

In accordance with a twelfth aspect of the invention, the optical connector plug defined by the eleventh aspect is characterized in that the rotation positioning portion for the ferrule is disposed at an axial leading end of the flange portion, and that the holder member includes therein an engagement portion formed in a predetermined engagement width along the axial direction of the optical fiber, thereby providing a predetermined clearance between the rotation positioning portion and the engagement portion.

In accordance with a thirteenth aspect of the invention, the optical connector plug defined by the twelfth aspect is characterized in that the rotation positioning portion of the flange portion comprises the key groove defined between the circumferentially opposite end faces of the split members, whereas the engagement portion comprises an engaging projection projecting into the key groove.

In accordance with a fourteenth aspect of the invention, the optical connector plug defined by the twelfth aspect is characterized in that the rotation positioning portion of the flange portion comprises the outer periphery of the flange portion, whereas the engagement portion is an engagement hole comprising a through hole extended axially.

In accordance with a fifteenth aspect of the invention, a fabrication method for ferrule including a ferrule cylindrical body for retaining an end of an optical fiber, and a flange portion shaped like a polygon or disc circumferentially projecting as provided on an outer periphery of the ferrule cylindrical body, including a rotation positioning portion for defining a position of the ferrule cylindrical body relative to a holder member of an optical connector plug, and comprising a plurality of split members each consisting of a circumferentially divided segment,

the method comprises the steps of inserting the optical fiber and a fiber core into the ferrule cylindrical body thereby fixing the fiber and core therein, and positioning and fixing the split members to an outer periphery of the ferrule cylindrical body in a manner that the rotation positioning portion is set to a predetermined position as providing a predetermined clearance relative to an engagement portion formed in the holder member.

In accordance with a sixteenth aspect of the invention, a fabrication method for ferrule including a ferrule cylindrical body for retaining an end of an optical fiber, and a flange member including a holder portion disposed at a trailing end of the ferrule cylindrical body for retaining a fiber core including the optical fiber and a cladding over an outer periphery of the optical fiber, and a flange portion shaped like a polygon or disc circumferentially projecting as provided on the outer periphery of the ferrule cylindrical body, including a rotation positioning portion for defining a position of the ferrule cylindrical body relative to a holder member of an optical connector plug, and comprising a plurality of split members each consisting of a circumferentially divided segment, the method comprises the steps of mounting the holder portion to a trailing end of the ferrule cylindrical body, inserting the optical fiber and fiber core into the ferrule cylindrical body and holder portion thereby fixing the fiber and core therein, and positioning and fixing the split members to the outer periphery of the holder portion in a manner that the rotation positioning portion is set to a predetermined position as providing a predetermined clearance relative to an engagement portion formed in the holder member.

In accordance with a seventeenth aspect of the invention, fabrication method for ferrule defined by the sixteenth aspect is characterized in that the optical fiber is a polarization-maintaining optical fiber, that the step of fixing the polarization-maintaining optical fiber in the ferrule cylindrical body is followed by a step of polishing an end face of the ferrule cylindrical body and optical fiber, and that in the step of positioning and fixing the split members to the outer periphery of the holder portion, a direction of a polarization plane of the optical fiber is observingly determined and the split members are positioned and fixed to the outer periphery of the holder portion in a manner to establish a predetermined positional relation between the rotation positioning portion and the polarization plane.

In accordance with an eighteenth aspect of the invention, the fabrication method for ferrule defined by the sixteenth aspect further comprises a step following the step of positioning and fixing the split members to the outer periphery of the holder portion and performed for polishing a leading end face of the ferrule cylindrical body and optical fiber with reference to the position of the rotation positioning portion thereby forming an obliquely projected face relative to a plane orthogonal to an axis of the optical fiber.

In accordance with a nineteenth aspect of the invention, the fabrication method for ferrule defined by any one of the sixteenth to eighteenth aspects is characterized in that the split members define a predetermined clearance between circumferentially opposite end faces thereof, that the rotation positioning portion comprises a key groove defined between the circumferentially opposite end faces of the split members, and that the step of positioning and fixing the split members to the outer periphery of the holder portion is performed using a jig including an engaging projection of a configuration equivalent to that of the engagement portion formed in the holder member.

In accordance with a twentieth aspect of the invention, the fabrication method for ferrule defined by any one of the sixteenth to eighteenth aspects is characterized in that the rotation positioning portion comprises the outer periphery of the flange portion, and that the step of positioning and fixing the split members to the outer periphery of the holder portion is performed using a jig formed with an engagement hole of a configuration equivalent to that of the engagement portion formed in the holder member.

In accordance with a twenty-first aspect of the invention, the fabrication method for ferrule defined by any one of the sixteenth to twentieth aspects is characterized in that the outer periphery of the holder portion comprises a tapered surface progressively decreased in outside diameter toward the leading end side, whereas an inside surface of the split member constituting the flange portion comprises a tapered surface progressively decreased in inside diameter toward the leading end side, and that in the step of positioning and fixing the split members to the outer periphery of the holder portion, the holder portion is pressed into place toward the leading end side and then fixed to place.

According to the invention, the flange portion is constituted by the split members formed of the circumferentially divided segments so that the assembly of the ferrule does not require the flange portion to be previously threaded onto the optical fiber or does not encounter the problem that the flange portion introduced from the leading end side causes damage to the leading end face of the optical fiber and ferrule cylindrical body. Thus, the assembly steps are simplified.

In addition, the size or position of the rotation positioning portion can be readily defined with high precision when the split members are fixed to places. Accordingly, when the ferrule is assembled in the optical connector plug, the rotation positioning portion is allowed to define the clearance between itself and the engagement portion formed in the holder member of the optical connector plug in an easy and highly precise manner.

### BRIEF DESCRIPTION OF THE DRAWINGS

FIG. 1 is a group of a perspective view and disassembled perspective view for illustrating a ferrule according to a first embodiment of the invention;

FIG. 2 is a group of a plan view and sectional view taken on the line A-A′ for illustrating the ferrule according to the first embodiment;

FIG. 3 is a disassembled perspective view showing an optical connector plug according to the first embodiment;

FIG. 4 is a group of a disassembled plan view and assembled sectional view for illustrating the optical connector plug according to the first embodiment;

FIG. 5 is a perspective view of a ferrule and assembly jig for illustrating a fabrication method for ferrule according to the first embodiment;

FIG. 6 is a perspective view of the ferrule and assembly jig for illustrating the fabrication method for ferrule according to the first embodiment;

FIG. 7 is a plan view of the ferrule and assembly jig for illustrating the fabrication method for ferrule according to the first embodiment;

FIG. 8 is a perspective view of the ferrule and assembly jig for illustrating the fabrication method for ferrule according to the first embodiment;

FIG. 9 is a group of a perspective view and plan view for illustrating another example of the ferrule according to first embodiment;

FIG. 10 is a sectional view taken on the line B-B′ in FIG. 9B for illustrating the another example of the ferrule according to the first embodiment;

FIG. 11 is a group of a perspective view and disassembled perspective view for illustrating a ferrule according to a second embodiment of the invention;

FIG. 12 is a group of a plan view and sectional view taken on the line C-C′ for illustrating the ferrule according to the second embodiment;

FIG. 13 is a disassembled perspective view showing an optical connector plug according to the second embodiment;

FIG. 14 is a group of a disassembled plan view and assembled sectional view for illustrating the optical connector plug according to the second embodiment;

FIG. 15 is a group of a perspective view and disassembled perspective view for illustrating a ferrule according to a third embodiment of the invention;

FIG. 16 is a group of a plan view and sectional view taken on the line D-D′ for illustrating the ferrule according to the third embodiment;

FIG. 17 is a disassembled perspective view showing an optical connector plug according to the third embodiment;

FIG. 18 is a group of a disassembled plan view and assembled sectional view for illustrating the optical connector plug according to the third embodiment;

FIG. 19 is an axial sectional view showing a ferrule according to another embodiment of the invention; and

FIG. 20 is a group of a perspective view and disassembled perspective view for illustrating a ferrule according to yet another embodiment of the invention.

### DESCRIPTION OF THE PREFERRED EMBODIMENTS

The invention will hereinbelow be described in detail with reference to the preferred embodiments thereof.

First Embodiment

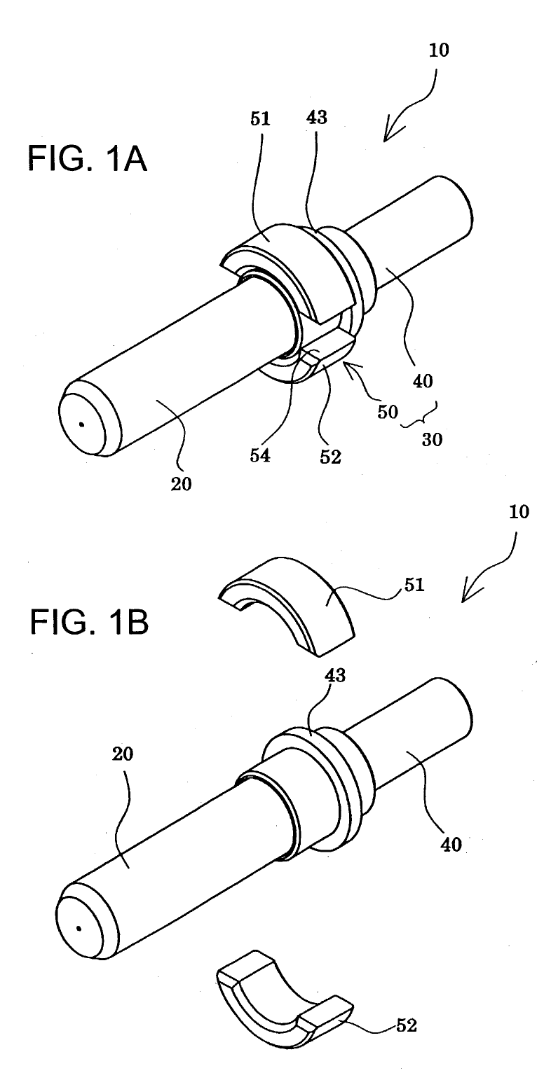

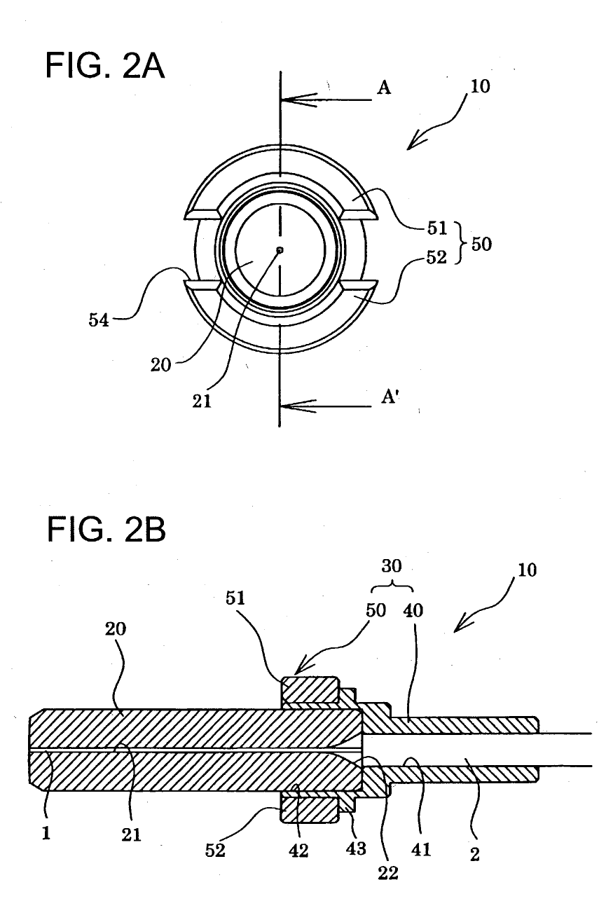

FIG. 1A is a perspective view showing a ferrule according to a first embodiment of the invention, whereas FIG. 1B is a disassembled perspective view thereof. FIG. 2A is a plan view showing a leading end face of the ferrule, whereas FIG. 2B is a sectional view taken on the line A-A′ in FIG. 2A.

As shown in FIGS. 1 and 2, a ferrule 10 comprises a ferrule cylindrical body 20 having an outside diameter of 2.5 mm, and a flange member 30 fitted on an end of the ferrule cylindrical body 20.

The ferrule cylindrical body 20 is substantially of a cylindrical shape and includes therein an optical-fiber insertion hole 21 axially extended therethrough and retaining an inserted optical fiber 1, such as a polarization-maintaining optical fiber or the like. Formed at a rear end of the optical-fiber insertion hole 21 is a tapered portion 22, an inside diameter of which is progressively increased toward an opening. The tapered portion 22 is provided such that a leading end of the optical fiber 1 being inserted in the optical-fiber insertion hole 21 may not be broken or folded by hitting against an end face of the ferrule cylindrical body 20.

Examples of a usable material for the ferrule cylindrical body 20 include ceramics such as zirconia and the like; plastics; and glasses such as crystallized glass, borosillicate glass, crystal and the like.

The flange member 30 comprises a holder portion 40 fitted on a trailing end of the ferrule cylindrical body 20, and a flange portion 50 joined to an outer periphery of the holder portion 40.

The holder portion 40 is formed with a fiber-core insertion hole 41 defined by a through hole communicated with the optical-fiber insertion hole 21 and adapted to receive a fiber core 2 comprising the optical fiber 1 and a cladding over an outer periphery thereof. A leading end portion of the fiber-core insertion hole 41 defines a greater diameter portion 42 fitted on the trailing end of the ferrule cylindrical body 20. Thus, the ferrule cylindrical body 20 is retained with its trailing end pressed into the greater diameter portion 42.

A flange 43 to be described hereinlater is formed on the outer periphery of the holder portion 40 at place near the trailing end of the greater diameter portion thereof. The flange 43 abuts against a rear end face of the flange portion 50 for restricting an axial rearward movement of the flange portion 50. The flange 43 serves not only to restrict the axial rearward movement of the flange portion 50 but also to prevent an end of a biasing spring from directly contacting the flange portion 50 when the ferrule is retained by an optical connector plug, which will be described hereinlater, thereby preventing the disengagement of the flange portion 50 from the holder portion 40.

On the other hand, the flange portion 50 comprises a plurality of split members or two split members 51, 52 according to the embodiment, which divide the outer periphery of the holder portion 40 into individual segments.

The split members 51, 52 are formed by dividing a disc like member into the individual segments, providing a predetermined clearance between a respective pair of circumferentially opposite end faces thereof.

The clearance defines a rotation positioning portion 54 which is engaged with an engagement portion disposed in a plug frame as a retaining member for retaining the ferrule 10 of the optical connector plug to be described hereinlater, thereby preventing the ferrule 10 from axially rotating relative to the plug frame.

That is, the rotation positioning portion 54 according to the embodiment is comprised of a key groove defined by circumferentially opposite end faces of the split members 51, 52.

Although a detailed description will be made hereinlater, the rotation positioning portion 54 comprised of such a key groove is formed as follows. Firstly, the holder portion 40 is fitted on the trailing end of the ferrule cylindrical body 20 to form an assembly consisting of the ferrule cylindrical body 20 and the holder portion 40. Subsequently, the polarization-maintaining optical fiber 1 is retained in the assembly and then the split members 51, 52 are fixed on the holder portion 40 as positioned relative to a polarization plane of the polarization-maintaining optical fiber 1.

The rotation positioning portion 54 may be positioned relative to the polarization plane with high precision by positioning and fixing the split members 51, 52 to the outer periphery of the holder portion 40 in this manner. Accordingly, propagation of high extinction ratio is achieved.

The split members 51, 52 may be fixed to places by means of, for example, laser welding such as with YAG laser or the like, ark welding or bonding with an adhesive.

Now, a detailed description will be made on the optical connector plug which retains the ferrule 10 for optical connection.

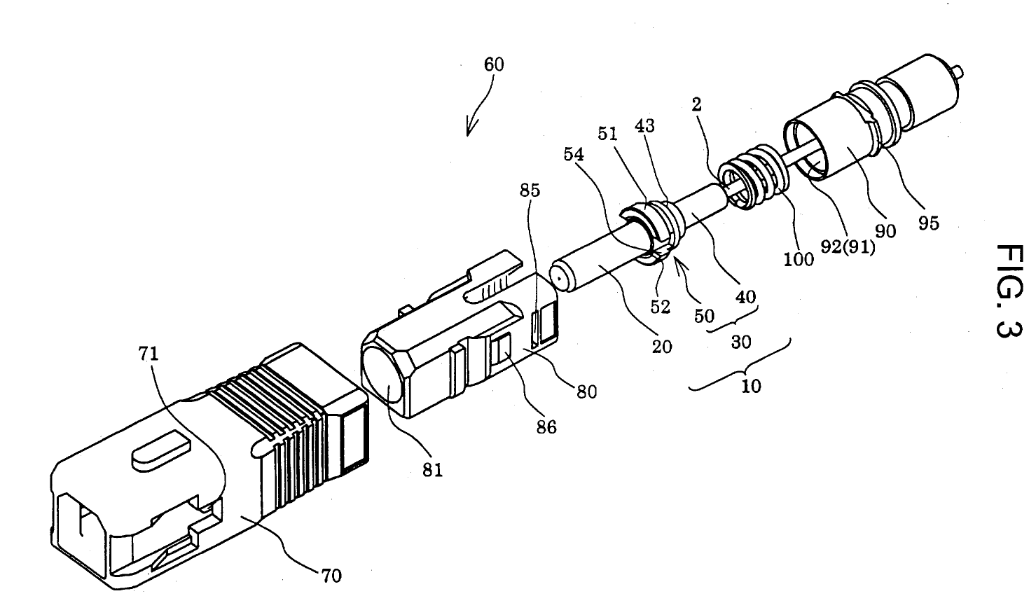

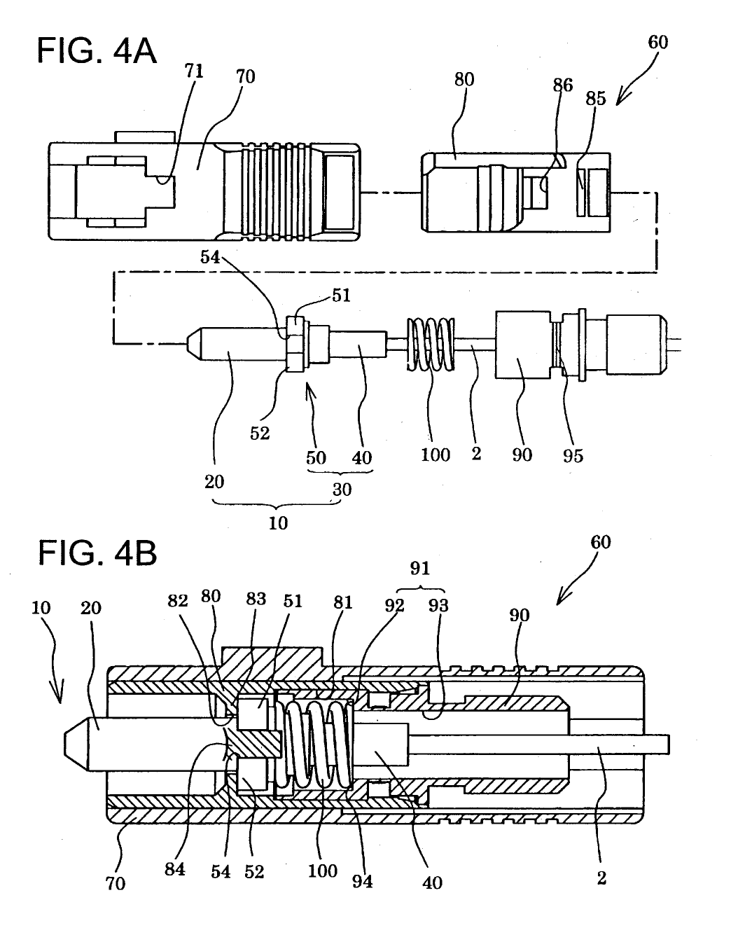

FIG. 3 is a disassembled perspective view showing the optical connector plug. FIG. 4A is a disassembled plan view showing the optical connector plug, whereas FIG. 4B is an assembled sectional view thereof.

As shown in the figures, an optical connector plug 60 according to the embodiment comprises a plug housing 70 fitted with an SC-type optical connector adapter; a plug frame 80 fitted in the plug housing 70 while receiving the ferrule 10 from rear; a stop ring 90 engaging, at a leading end thereof, with a trailing end of the plug frame 80; and a biasing spring 100 retained between the ferrule 10 and the stop ring 90 for axially biasing the ferrule 10 toward the leading end side.

The plug frame 80 for receivingly retaining the ferrule 10 includes a ferrule insertion hole 81 longitudinally extended therethrough. The plug frame is formed, for example, from a plastic material in an outward shape substantially of a rectangular section. The ferrule insertion hole 81 has an inside diameter somewhat greater than the outside diameter of the ferrule cylindrical body 20 and includes a projecting flange 83 formed with a projection hole 82 permitting only the ferrule cylindrical body 20 to project therefrom.

The ferrule insertion hole 81 is further formed with an engagement portion which adjoins the projecting flange 83 and engages the rotation positioning portion 54 comprised of the key groove of the flange portion 50.

According the embodiment, the key grooves define the rotation positioning portions 54 provided at the flange portion 50 and hence, as shown in FIG. 4B, engaging projections 84, as the engagement portion, projecting toward the axis are provided at two diametrally opposite places of the ferrule insertion hole 81.

The engaging projection 84 is formed in a predetermined engaging width along the axial direction or in a predetermined thickness with respect to the axial direction, so as to define a predetermined clearance relative to the rotation positioning portion 54.

Thus, the ferrule 10 retained in the ferrule insertion hole 81 is restricted by the rotation positioning portion 54 so as to be allowed to rotate axially within a predetermined rotation angle relative to the plug frame 80. When the optical connector plug is in end-to-end connection with another optical connector plug, the rotation positioning portion restricts the rotation angle of the ferrule 10 for improving the propagation of high extinction ratio with reduced connection loss and reflection return loss.

The plug frame 80 is further formed with two lock holes 85 communicated with the ferrule insertion hole 81 and opening into an outer periphery of the plug frame. The lock hole 85 is designed to be engaged with an locking portion 95 provided at a leading end of the stop ring 90 which will be described hereinlater.

The stop ring 90 includes a through hole 91 axially extending therethrough for receiving the holder portion 40 of the flange member 30 and is formed from a metal, such as stainless steel for example, or a plastic in a cylindrical shape.

The through hole 91 includes a greater diameter portion 92 disposed on the leading end side and capable of receiving the biasing spring 100, and a smaller diameter portion 93 disposed on the trailing end side and capable of receiving the holder portion 40 of the flange member 30. A difference of the inside diameters of the greater and smaller diameter portions 92, 93 defines a step portion 94, against which one end of the biasing spring 100 is pressed.

The biasing spring 100 has the other end thereof pressed against a trailing end face of the flange 43 provided on the outer periphery of the holder portion 40 so that the ferrule 10 is biased axially forwardly relative to the stop ring 90. This arrangement keeps the biasing spring 100 out of direct contact with the flange portion 50 thereby preventing the flange portion 50 from disengaging from the holder portion 40.

Formed on an outer periphery of the leading end of the stop ring 90 is the locking portion 95 which projects into the lock holes 85 when the stop ring 90 is inserted into the ferrule insertion hole 81 of the plug frame 80. The locking portion 95 has a tapered configuration progressively decreased in projection toward the leading end. The locking portion 95 is advanced into the ferrule insertion hole 81 as distending the trailing end of the plug frame 80 until the locking portion is locked to the lock holes 85.

The ferrule 10 may be retained in the plug frame 80 of such a configuration in the following manner. The ferrule 10 retaining the optical fiber 1 is inserted into the ferrule insertion hole 81 of the plug frame 80 so as to bring the rotation positioning portion 54 defined by the key groove on the flange portion 50 into engagement with the engaging projections 84. Subsequently, the biasing spring 100 and stop ring 90, previously threaded onto the fiber core 2, are sequentially inserted into the plug frame so as to lock the locking portion 95 of the stop ring 90 to the lock holes 85. Thus, the stop ring 90 is secured to the plug frame 80. At this time, a leading end face of the flange portion 50 of the ferrule 10 abuts against the projecting flange 83 of the plug frame 80, whereby the ferrule 10 projects a predetermined amount from the projection hole 82 of the projecting flange 83 as restricted in the movement toward the leading end side and is retained as axially forwardly biased.

Additionally, the ferrule 10 retained in this manner is so restricted by the rotation positioning portion 54 as to be allowed to rotate axially within a predetermined rotation angle relative to the plug frame 80.

The plug frame 80 thus assembled is provided with two engaging projections 86 on the outer periphery thereof, which engage with the plug housing 70. These engaging projections 86 engage with engagement recesses 71 of the plug housing 70 which, in turn, retains the plug frame 80 therein as allowing the plug frame to move within a predetermined axial range. Thus is constructed the optical connector plug 60.

When the optical connector plugs 60 of this configuration are interconnected in end-to-end relation by means of an unillustrated optical connector adapter, the optical fibers 1 thereof can be placed in an end-to-end optical interconnection with their polarization planes aligned to each other because the optical connector plugs are restrictively allowed to rotate axially relative to each other within a predetermined rotation angle. Thus, the optical interconnection can achieve the improved propagation of high extinction rate with reduced connection loss and reflection return light.

Now, a fabrication method for such a ferrule will be described in detail.

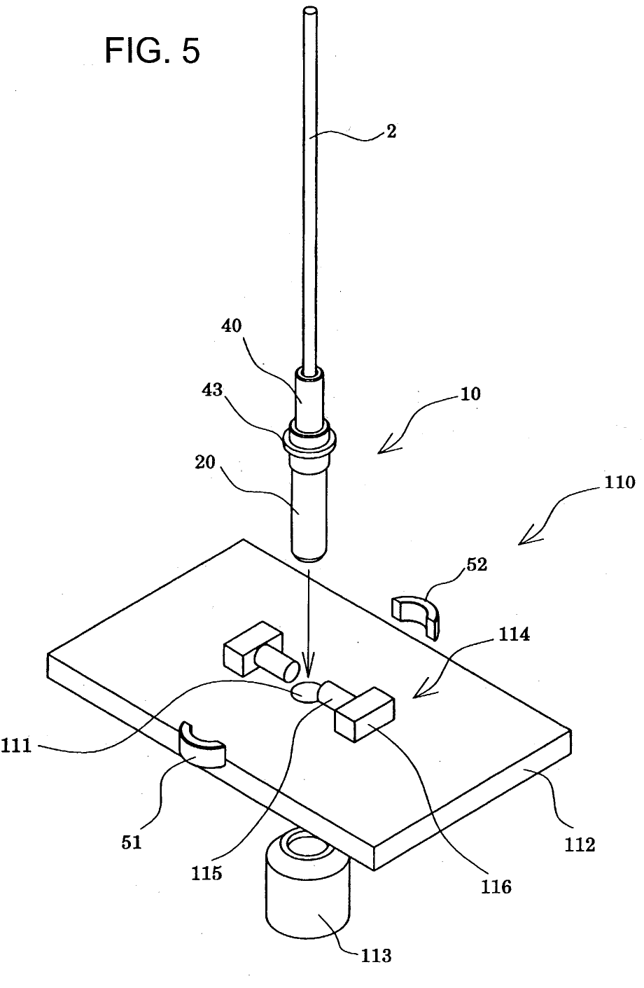

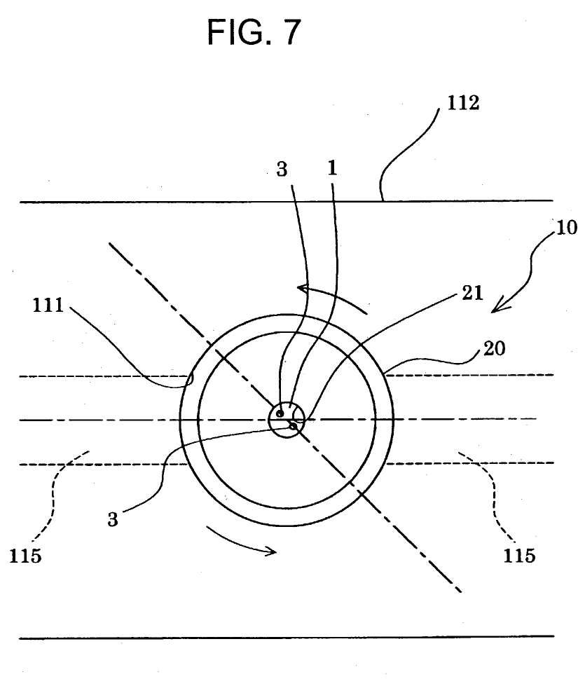

FIGS. 5, 6 and 8 are perspective views each showing a ferrule and an assembly jig for illustrating a fabrication method for the ferrule. FIG. 7 is a plan view of the ferrule and assembly jig for illustrating the fabrication method for the ferrule.

First, the holder portion 40 is fitted on the trailing end of the ferrule cylindrical body 20 thereby to form an assembly including the ferrule cylindrical body 20 and the holder portion 40.

The optical fiber 1 and fiber core 2 are adhesively retained in the resultant assembly, while a leading end face of the ferrule cylindrical body 20 and optical fiber 1 is polished by, for example, a face grinding device or the like.

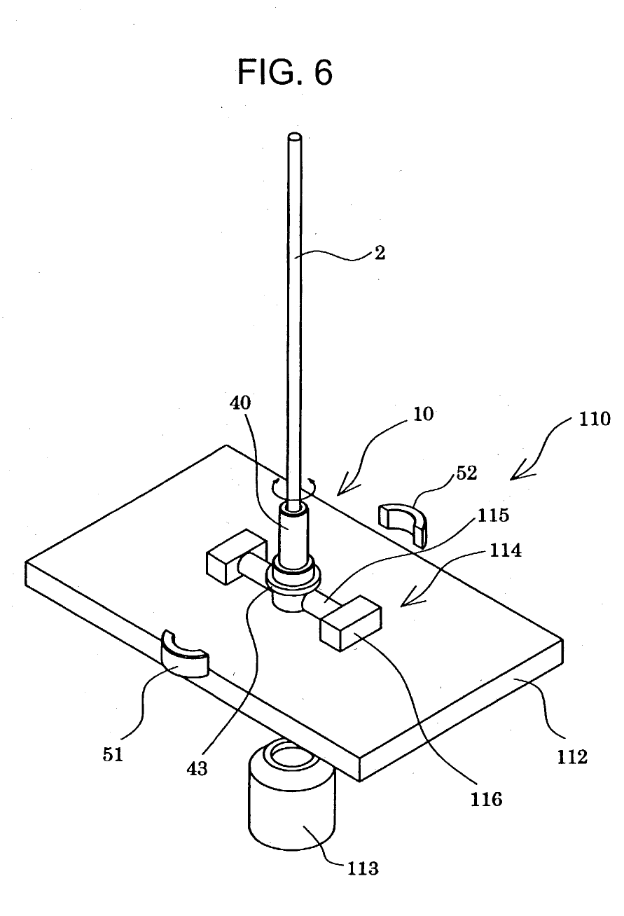

After the face polishing, the assembly retaining the optical fiber 1 is positioned in an assembly jig 110, as shown in FIG. 6.

As shown in FIG. 5, the assembly jig 110 comprises a plate-like jig 112 including a through hole 111 having an inside diameter somewhat greater than the ferrule cylindrical body 20 for receiving only the ferrule cylindrical body 20; a measurement device 113, such as a microscope or the like, for observing the end face of the optical fiber 1 exposed at the end face of the ferrule cylindrical body 20 inserted in the through hole 111; and an engaging jig 114 disposed on the jig 112 on the opposite side from the measurement device 113 and having an engagement width equal to that of the engaging projections 84 of the plug frame 80.

According to the embodiment, the engaging jig 114 includes two cylindrical members 115 having an engagement width equal to that of the engaging projections 84 provided in the plug frame 80 and located at diametrally opposite places of the through hole 111 as presenting their distal ends flush with an inside surface of the through hole 111, and fixing members 116 disposed at individual proximal ends of the cylindrical members 115 for securing the cylindrical members 115 to the jig 112.

When the ferrule cylindrical body 20 is inserted in the through hole 111 of the assembly jig 110, as shown in FIG. 6, a leading end face of the flange 43 of the holder portion 40 abuts against edges of the distal ends of the cylindrical members 115, the distal ends of which are flush with the inside surface of the through hole 111. Thus, the ferrule cylindrical body is retained as restricted in movement along an insertion direction.

After the assembly is inserted in the through hole 111 in this manner, the end face of the optical fiber 1 is observed by the measurement device 113 to determine the direction of the polarization plane of the optical fiber, as shown in FIG. 7. Then the assembly is axially rotated and positioned so as to establish a predetermined positional relation between the polarization plane of the optical fiber 1 and the engaging jig 114. The positioning to establish the predetermined positional relation between the polarization plane and the engaging jig 114 is not particularly limited. The positioning may be performed to align the polarization plane with a direction in which the cylindrical members 115 of the engaging jig 114 oppose each other. Otherwise, the polarization plane may be positioned orthogonal to the direction in which the cylindrical members 115 of the engaging jig 114 oppose each other. According to the embodiment, the positioning aligns the polarization plane with the direction in which the cylindrical members 115 oppose each other.

According to the embodiment, the direction of the polarization plane means a direction defined by a line between centers of two stress providing portions 3 observed on the leading end face of the optical fiber 1.

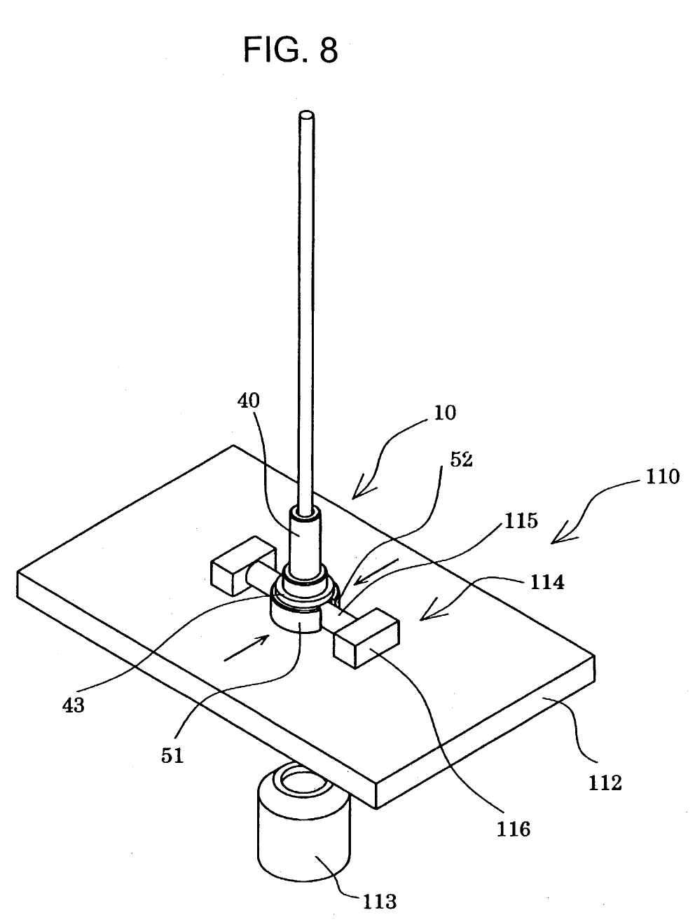

After the polarization plane of the optical fiber 1 is thus positioned relative to the engaging jig 114 by axially rotating the assembly, the split members 51, 52 are positioned and fixed to the outer periphery of the holder portion 40 in a manner to clamp the cylindrical members 115 of the engaging jig 114 between the circumferentially opposite end faces thereof, as shown in FIG. 8.

Since the cylindrical member 115 of the engaging jig 114 is formed in the same engagement width as that of the engaging projection 84 of the plug frame 80, the rotation positioning portion 54 comprised of the key groove defined by the circumferentially opposite ends of the split members 51, 52 may have the same engagement width as that of the engaging projection 84 of the plug frame 80. In practice, it is preferred that the cylindrical member 115 is formed in an engagement width of about 1.0 μm greater than that of the engaging projection 84 for providing a clearance of about 10 μm between the rotation positioning portion 54 and the engaging projection 84, such that the ferrule 10 is allowed to move axially when the rotation positioning portion 54 is engaged with the engaging projection 84 in the plug frame 80.

Examples of a method for securing the split members 51, 52 to the outer periphery of the holder portion 40 include laser welding such as with YAG laser or the like, welding such as ark welding or the like, and bonding using an adhesive or the like.

If the split members 51, 52 to clamp the cylindrical member 115 between their circumferentially opposite end faces abut against the outer periphery of the holder portion 40 on their inner sides, the split members 51, 52 are unable to clamp the cylindrical member 115 between their end faces. Consequently, the key groove formed between the opposite ends of the split members 51, 52 cannot define the rotation positioning portion 54 of the predetermined width. Therefore, the split members 51, 52 may preferably be configured to define a predetermined clearance between their inner peripheries except for their ends and the outer periphery of the holder portion 40. The clearance may be readily formed by configuring the split members 51, 52 or the holder portion 40 to have an elliptical radial section.

Assembling the ferrule 10 in this manner negates the need for introducing the split members 51, 52, constituting the flange portion 50, from the leading end side of the ferrule cylindrical body 20 for fitting the split members on places. This assuredly prevents the flange portion from causing damage to the leading end face of the ferrule cylindrical body 20 and optical fiber 1.

The engaging jig 114 may be used for forming the rotation positioning portion 54 comprised of the key groove at the flange portion 50, thereby providing for an easy and high-precision forming of a desired clearance between the engaging projection 84 of the plug frame 80 and the rotation positioning portion 54.

Hence, the ferrule can be readily and quickly assembled with high precision, resulting in cost reduction.

According to the aforementioned first embodiment, the flange 43 is provided on the outer periphery of the holder portion 40 at place near the proximal end thereof, such that the flange 43 may prevent the rearward movement of the flange portion 50 while permitting the one end of the biasing spring 100 to abut thereagainst for preventing the biasing spring 100 from breaking the juncture. However, the configuration of the flange 43 is not particularly limited. For instance, the flange 43 may be provided on the outer periphery of the holder portion at place near the leading end thereof.

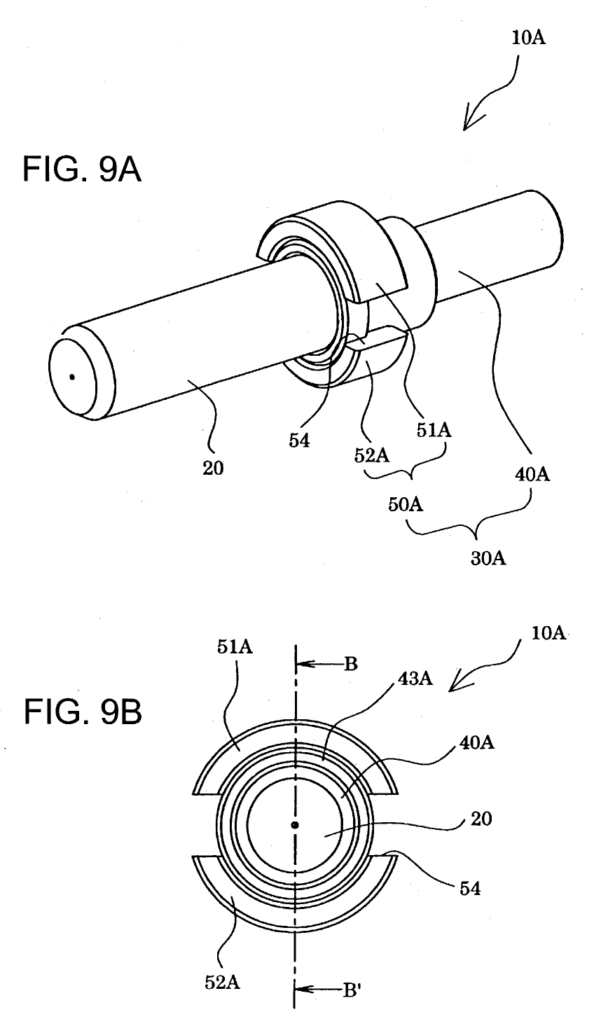

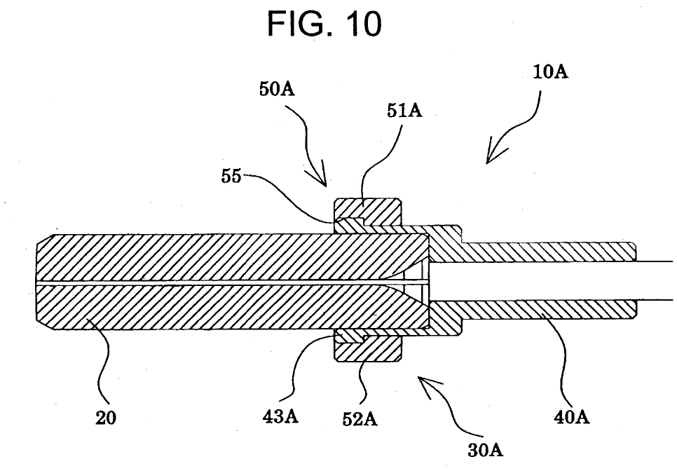

An example of the above configuration is shown in FIGS. 9 and 10. FIG. 9A is a perspective view showing another example of the first embodiment whereas FIG. 9B is a plan view showing an end face. FIG. 10 is a sectional view taken on the line B-B′ in FIG. 9B.

A ferrule 10A comprises the ferrule cylindrical body 20 and a flange member 30A. A holder portion 40A of the flange member 30A is provided with a flange 43A at a leading end of an outer periphery thereof.

Split members 51A, 52B constituting a flange portion 50A are each formed with a step 55 in the inner periphery thereof, the step 55 circumferentially extended and formed in conformity with the shape of the flange 43A.

The steps 55 of the flange portion 50A are fitted with the flange 43A whereby the flange portion 50A is secured to the outer periphery of the holder portion 40A as restricted in axial movement toward the leading end side.

When the ferrule 10A of this configuration is retained in the plug frame 80, the one end of the biasing spring 100 abuts against the trailing end of the flange portion 50A so that the flange portion 50A is biased toward the leading end side. However, the flange portion 50A is secured to the outer periphery of the holder portion 40A as fitted with the flange 43A and hence, the flange portion 50A does not disengage from the holder portion 40A.

Second Embodiment

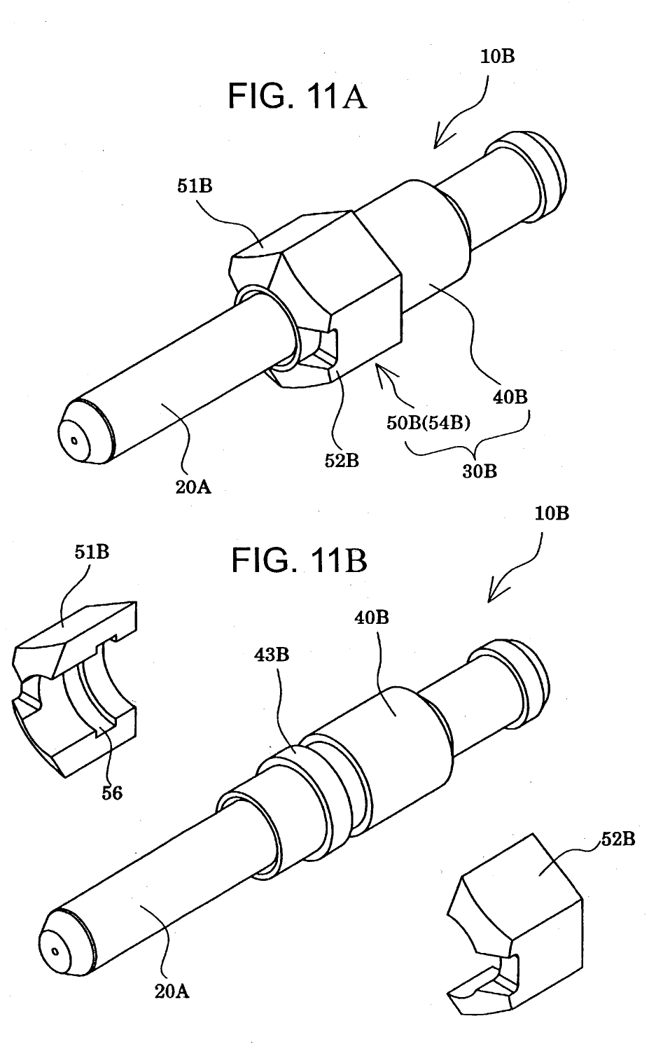

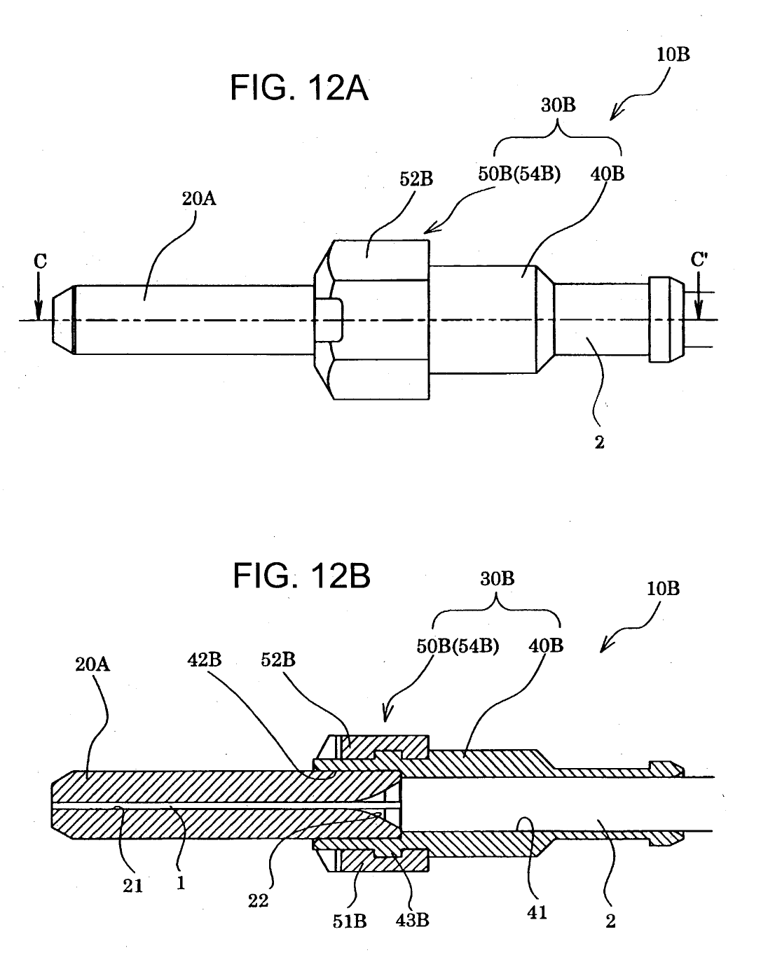

FIG. 11A is a perspective view showing a ferrule according to a second embodiment of the invention, whereas FIG. 11B is a disassembled perspective view thereof. FIG. 12A is a plan view showing the ferrule, whereas FIG. 12B is a sectional view taken on the line C-C′ in FIG. 12A.

It is noted that like parts to those of the first embodiment are represented by the same reference characters, respectively, and the description thereof is dispensed with.

As shown in the figures, a ferrule 10B according to the embodiment comprises a ferrule cylindrical body 20A formed from a ceramic material such as zirconia or a glass material and including the optical-fiber insertion hole 21 for retaining the inserted optical fiber, and a flange member 30B fitted on one end of the ferrule cylindrical body 20A.

The flange member 30B comprises a holder portion 40B fitted on a trailing end of the ferrule cylindrical member 20A, and a flange portion 50B joined to an outer periphery of the holder portion 40B.

The holder portion 40B is formed with a fiber-core insertion hole 41 defined by a through hole communicated with the optical-fiber insertion hole 21 and adapted to receive the fiber core 2 comprising the optical fiber 1 and a cladding over the outer periphery thereof. A leading end portion of the fiber-core insertion hole 41 defines a greater diameter portion 42B fitted on the trailing end of the ferrule cylindrical body 20A. Thus, the ferrule cylindrical body 20A is retained with its trailing end pressed into the greater diameter portion 42B.

A flange 43B is provided on an outer periphery of the holder portion 40B, extended along the circumferential length of the holder portion.

On the other hand, the flange portion 50B comprises a plurality of split members or two split members 51B, 52B according to the embodiment, which divide the outer periphery of the holder portion 40B into individual segments.

The split members 51B, 52B are formed by dividing a cylinder substantially of a hexagonal radial section into individual pieces, so that a rotation positioning portion 54B of the flange portion 50B constituted by the split members 51B, 52B is defined by the six faces of the outer periphery.

According to the embodiment, the rotation positioning portion 54B is defined by the six faces of the outer periphery of the flange portion 50B. Hence, a plug frame 80A to be described hereinlater has an engagement hole 84A, as the engagement portion, which has a radial section substantially conforming to that of the rotation positioning portion 54B.

The flange portion 50B constituted by the split members 51B, 52B is formed with a groove 56 in its inner periphery, the groove 56 circumferentially extended for engagement with the flange 43B. That is, the groove 56 of the flange portion 50B constituted by the split members 51B, 52B is engaged with the flange 43B, whereby the flange portion 50B is joined to the outer periphery of the holder portion 40B as prevented from moving axially forwardly or rearwardly.

Likewise to the foregoing first embodiment, such a ferrule 10B may be readily fabricated by means of an assembly jig provided with an engaging jig having an equivalent configuration to that of the engagement hole 84A of the plug frame 80A.

Now, an optical connector plug for retaining the ferrule 10B of the embodiment will be described.

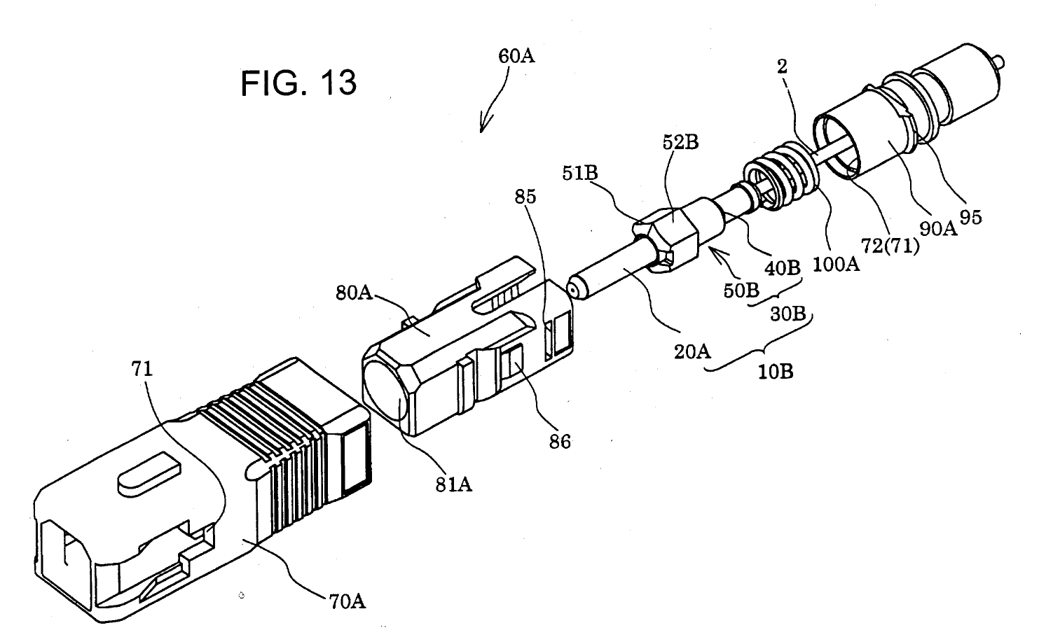

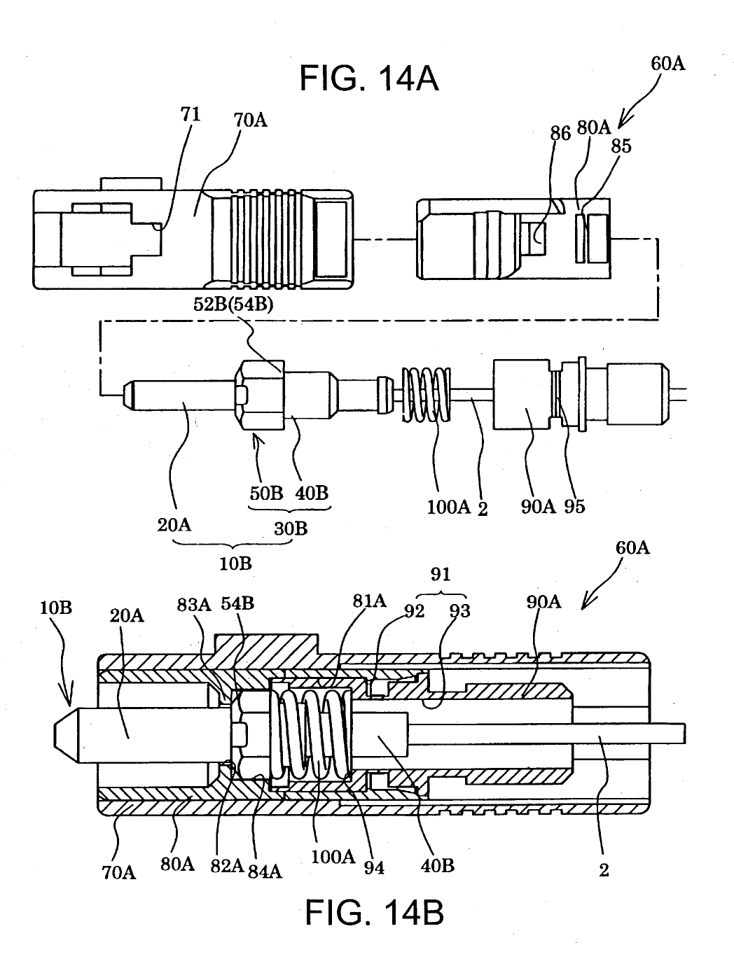

FIG. 13 is a disassembled perspective view showing an optical connector plug. FIG. 14A is a disassembled plan view showing the optical connector plug, whereas FIG. 14B is an assembled sectional view thereof.

As shown in FIGS. 13 and 14, an optical connector plug 60A according to the embodiment comprises a plug housing 70A fitted with an optical connector adapter; the plug frame 80A fitted in the plug housing 70A while receiving the ferrule 10B from rear; a stop ring 90A engaging, at a leading end thereof, with a trailing end of the plug frame 80A; and a biasing spring 100A retained between the ferrule 10B and the stop ring 90A for axially biasing the ferrule 10B toward the front side.

The plug frame 80A for receivingly retaining the ferrule 10B includes a ferrule insertion hole 81A longitudinally extended therethrough. The ferrule insertion hole 81A has an inside diameter somewhat greater than an outside diameter of the ferrule cylindrical body 20A and includes a projecting flange 83A formed with a projection hole 82A permitting only the ferrule cylindrical body 20A to project therefrom.

The ferrule insertion hole 81A is further formed with the engagement portion which adjoins the projecting flange 83A and engages the rotation positioning portion 54B defined by the six faces of the outer periphery of the flange portion 50B.

According to the embodiment, the rotation positioning portion 54B of the flange portion 50B is defined by the six faces of the outer periphery thereof. Therefore, the engagement portion takes the form of the engagement hole 84A having a hexagonal radial section conforming to that of the rotation positioning portion 54B.

The engagement hole 84A is configured to have a predetermined engagement width along the axial direction or to define a cavity of a predetermined size and axial length, such as to provide a predetermined clearance relative to the rotation positioning portion 54B of the ferrule 10B.

Hence, the ferrule 10B retained in the ferrule insertion hole 81A is so restricted by the rotation positioning portion 54B as to be allowed to rotate axially within a predetermined rotation angle relative to the plug frame 80A. Thus, when the optical connector plug is in an end-to-end connection with another optical connector plug, the ferrule 10B is restricted in the rotation angle thereby achieving the optical connection featuring the propagation of high extinction ratio with reduced connection loss and reflection return light.

The biasing spring 100A for axially biasing the ferrule 10B toward the leading end side abuts atone end against a trailing end of the flange portion 50B. However, since the split members 51B, 52B constituting the flange portion 50B are joined to the holder portion 40B by way of engagement between the groove 56 and the flange 43B on the outer periphery of the holder portion 40B, the flange portion 50B does not disengage from the holder portion 40B.

The stop ring 90A fitted on the trailing end of the ferrule 10B for retaining the ferrule 10B in the plug frame 80A, the plug housing 70A and the like are configured the same way as those of the first embodiment and hence, the description thereof is dispensed with.

Third Embodiment

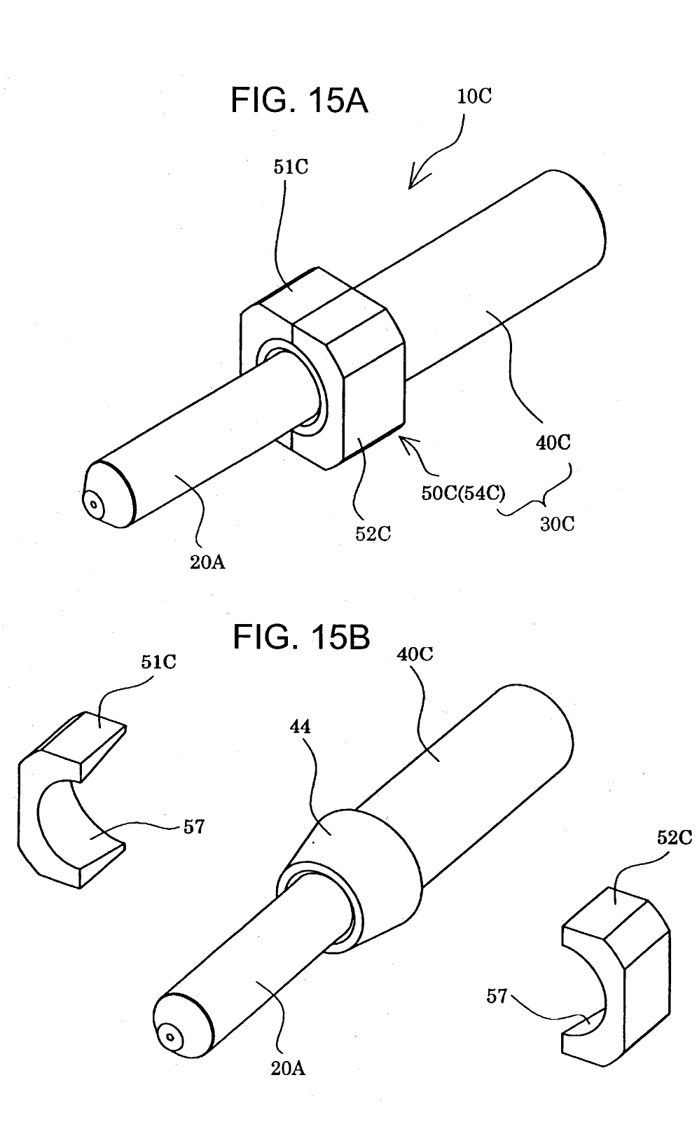

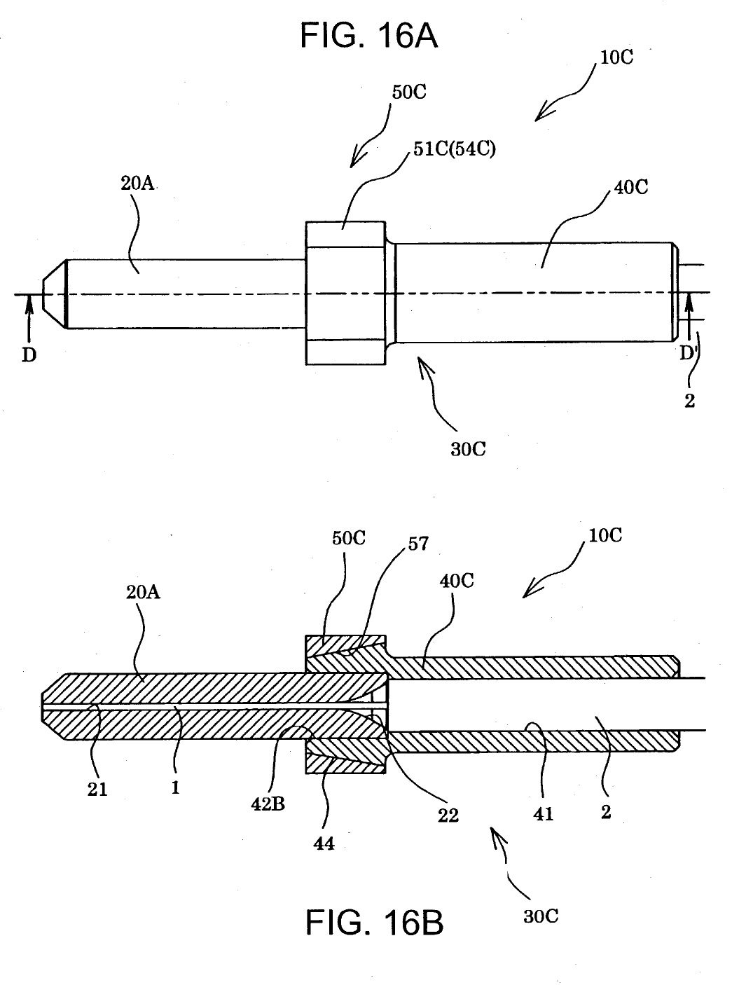

FIG. 15A is a perspective view showing a ferrule according to a third embodiment of the invention, whereas FIG. 15B is a disassembled perspective view thereof. FIG. 16A is a plan view of the ferrule, whereas FIG. 16B is a sectional view taken on the line D-D′ in FIG. 16A.

As shown in the figures, a ferrule 10C according to the embodiment comprises a ferrule cylindrical body 20A formed with the optical-fiber insertion hole 21 for retaining the optical fiber 1, and a flange member 30C.

The flange member 30C comprises a holder portion 40C fitted on a trailing end of the ferrule cylindrical body 20A, and a flange portion 50C joined to an outer periphery of the holder portion 40C.

The holder portion 40C is formed with the fiber-core insertion hole 41 defined by a through hole communicated with the optical-fiber insertion hole 21 and adapted to receive the fiber core 2 comprising the optical fiber 1 and a cladding over the outer periphery thereof.

A leading end portion of the fiber-core insertion hole 41 defines a greater diameter portion 42B fitted on the trailing end of the ferrule cylindrical body 20A.

The holder portion 40C is formed with a first tapered surface 44 on an outer periphery of a leading end thereof, the tapered surface progressively decreased in outside diameter toward the leading end.

On the other hand, the flange portion 50C comprises a plurality of or two separate split members 51C, 52C according to the embodiment, which divides the outer periphery of the holder portion 40C into individual segments.

The split members 51C, 52C are formed by dividing a cylinder substantially of a rectangular radial section into individual pieces, so that a rotation positioning portion 54C of the flange portion 50C constituted by the split members 51C, 52C is defined by the four faces of the outer periphery.

According to the embodiment, the rotation positioning portion 54C is defined by the four faces of the outer periphery of the flange portion 50C. Hence, a plug frame 80B to be described hereinlater has an engagement hole 84B, as the engagement portion, which has a radial section in conformity with that of the rotation positioning portion 54C.

An inner periphery of the flange portion 50C constituted by the split members 51C, 52C is defined by a second tapered surface 57 progressively decreased in inside diameter toward the leading end side.

The ferrule 10C is adapted to position the split members 51C, 52C on the outer periphery of the holder portion 40C in the following manner. The second tapered surfaces 57 on the inner peripheries of the split members 51C, 52C are brought into sliding contact with the first tapered surface 44 on the outer periphery of the holder portion 40C. The split members in this state are pressed against an engaging jig having a cavity equivalent to the engagement hole 84B of the plug frame 80B. This permits the formation of the rotation positioning portion 54C free from a clearance relative to the engagement hole 84B. In practice, however, it is preferred to form a clearance on the order of 10 μm for allowing an axial movement of the ferrule 10C with the rotation positioning portion 54C engaged with the engagement hole 84B in the plug frame 80B.

Now, description is made on an optical connector plug for retaining the ferrule 10C according to the embodiment.

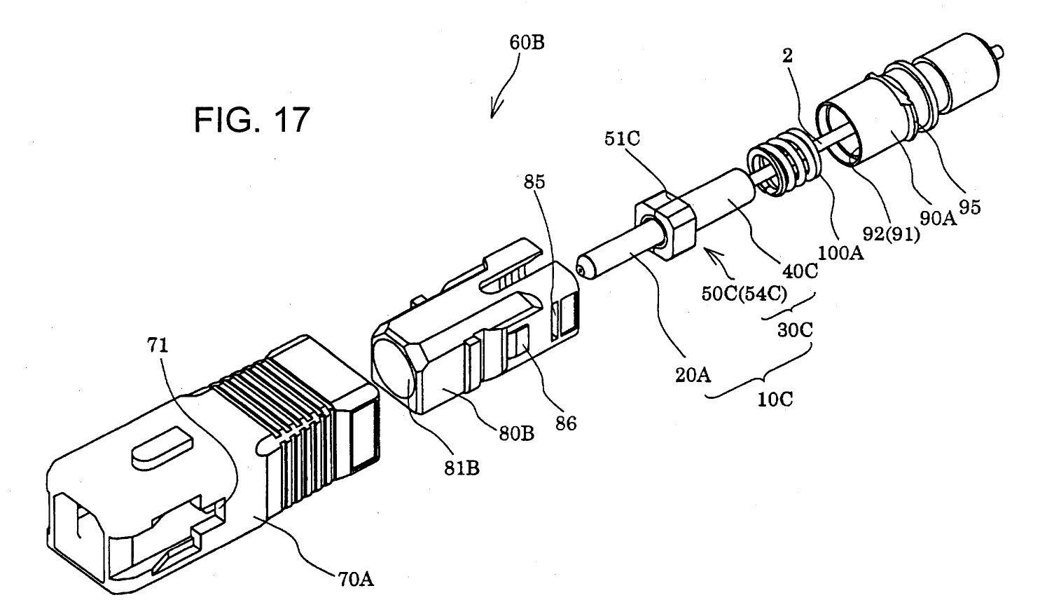

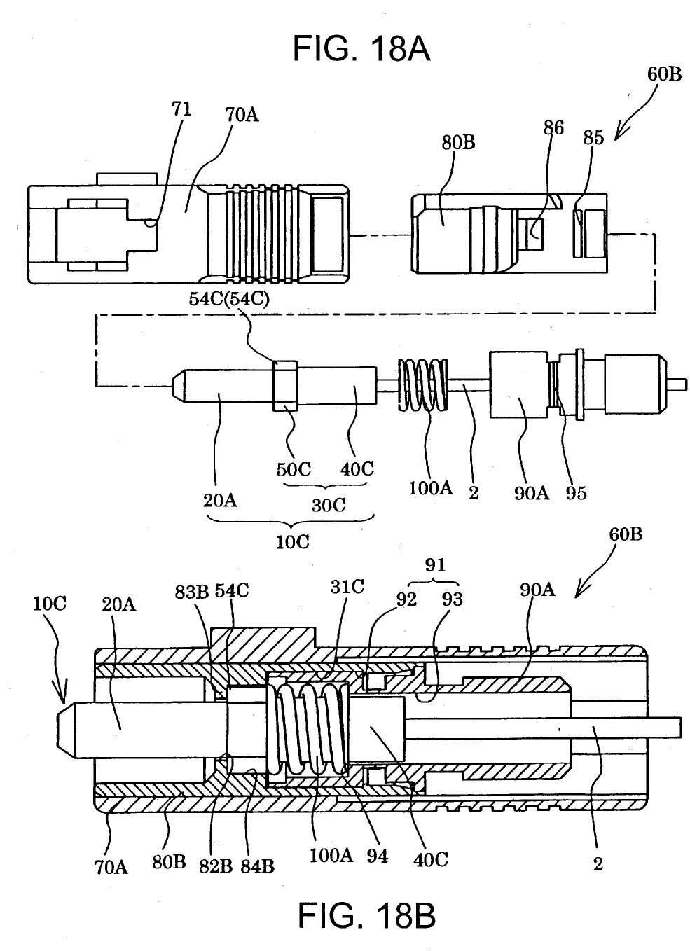

FIG. 17 is a disassembled perspective view showing an optical connector plug. FIG. 18A is a disassembled plan view showing the optical connector plug, whereas FIG. 18B is an assembled sectional view thereof.

As shown in the figures, an optical connector plug 60B according to the embodiment comprises the plug housing 70A fitted with an optical connector adapter; the plug frame 80B fitted in the plug housing 70A while receiving the ferrule 10C from the rear; the stop ring 90A engaging, at the leading end thereof, with the trailing end of the plug frame 80B; and the biasing spring 100A retained between the ferrule 10C and the stop ring 90A for axially biasing the ferrule 10C toward the leading end side.

The plug frame 80B includes a ferrule insertion hole 81B longitudinally extended therethrough. The ferrule insertion hole 81B has an inside diameter somewhat greater than the outside diameter of the ferrule cylindrical body 20A and includes a projecting flange 83B formed with a projection hole 82B permitting only the ferrule cylindrical body 20A to project therefrom.

The ferrule insertion hole 81B is further formed with the engagement portion which adjoins the projecting flange 83B and engages the rotational positioning portion 54C comprised of the four outer peripheral sides of the flange portion 50C.

According to the embodiment, the rotation positioning portion 54C of the flange portion 50C is defined by the four outer peripheral sides thereof and hence, the engagement portion takes the form of an engagement hole 84B having a radial rectangular section in conformity with the rotation positioning portion 54C, as shown in FIG. 18B.

The engagement hole 84B is configured to have a predetermined engagement width along the axial direction or to define a cavity of a predetermined size and axial length, such as to provide a predetermined clearance relative to the rotation positioning portion 54C of the ferrule 10C.

Thus, the ferrule 10C retained by the ferrule insertion hole 81B is restricted by the rotation positioning portion 54C so as to be allowed to rotate axially within a predetermined angle relative to the plug frame 80B. When connected in end-to-end connection with another optical connector plug, the optical connector plug is adapted to limit the rotation angle of the ferrule 10C thereby achieving the propagation of high extinction ratio with reduced connection loss and reflection return loss.

In the optical connector plug 60B, other components than the plug frame 80B, which include the plug housing 70A, stop ring 90A and biasing spring 100A, are constructed the same way as those of the second embodiment and hence, the description thereof is dispensed with.

Other Embodiments

While the first to third embodiments of the invention have been described, it is to be understood that the fundamental constitutions of the ferrule, fabrication method for the same and optical connector plug of the invention are not limited to the foregoing embodiments.

According to the first to third embodiments, the flange portion 50, 50A, 50B or 50C consists of two split members 51-51A or 51-52C. However, the invention is not limited to this and the flange portion may consist of more than two split members.

Although the third embodiment is arranged such that the first tapered surface 44 is formed on the outer periphery of the holder portion 40C whereas the second tapered surface 57 is formed on the inner periphery of the flange portion 50C, the invention is not limited to this arrangement. For instance, the ferrules 10 to 10B of the first and second embodiments may have the arrangement wherein the holder portion and the flange portion are brought into sliding contact on their tapered surfaces for positioning and fixing the flange portion to the holder portion.

Such a positioning via the sliding contact between the tapered surfaces permits the size or position of the rotation positioning portion to be readily determined with high precision.

Although the first to third embodiments are arranged such that the ferrule cylindrical body 20, 20A retains the optical fiber 1 whereas the flange member 30-30B retains the fiber core 2, the invention is not limited to this. For instance, the ferrule cylindrical body 20, 20A may retain both the optical fiber 1 and fiber core 2.

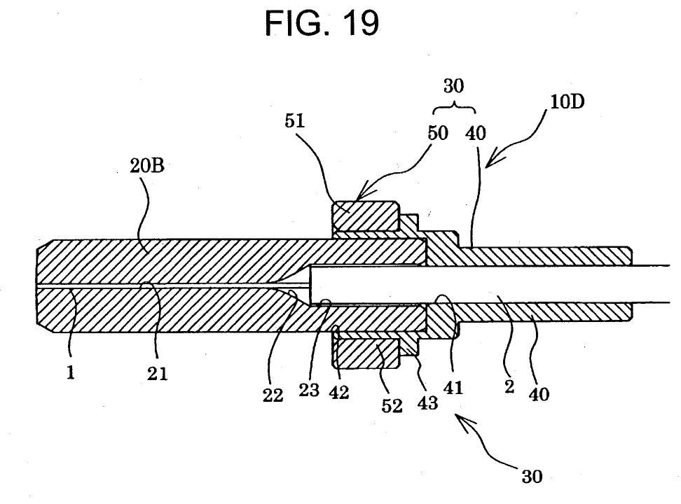

An example of such an arrangement is shown in FIG. 19, which is a sectional view taken along an axis of a ferrule.

FIG. 19 illustrates an exemplary modification of the first embodiment. As shown in the figure, a ferrule cylindrical body 20B of a ferrule 10D includes the optical-fiber insertion hole 21 extended therethrough, and a communication hole 23 formed rearwardly of the tapered portion 22 formed at the trailing end of the optical-fiber insertion hole. The communication hole 23 has a greater inside diameter than that of the optical-fiber insertion hole 21 and communicates with the fiber-core insertion hole 41 of the flange member 30.

Where the ferrule cylindrical body has such a configuration, the same effects as the aforementioned first embodiment may be attained by providing the flange member 30 including the flange portion 50, constituted by the split members 51, 52, and the holder portion 40. It goes without saying that the second and third embodiments may be provided with a similar communication hole to that of FIG. 19 in the ferrule cylindrical body.

Although the first to third embodiments illustrate the polarization-maintaining optical fiber as the optical fiber 1 retained by the ferrule 20, 20A, the invention is not limited to this and a common optical fiber 1 may be used. Furthermore, the ferrule may be a type for use in an oblique PC connector wherein the leading end face of the ferrule cylindrical body 20, 20A is obliquely projected relative to the plane orthogonal to the axis of the optical fiber. In the case of the ferrule for use in the oblique PC connector, the same procedure as in the first to third embodiments may be taken. That is, the optical fiber is retained by the assembly including the ferrule cylindrical body and the holder portion, and the leading end face of the assembly is polished to form the obliquely projected face. Subsequently, the split members constituting the flange portion are positioned according to the inclination of the projected face and fixed to the outer periphery of the holder portion. Alternatively, the procedure may include the steps of assembling the ferrule cylindrical body, holder portion and split members; inserting the optical fiber into the ferrule cylindrical body; and polishing the leading end face of the assembly to form the obliquely projected face having a predetermined positional relation with the rotation positioning portion.

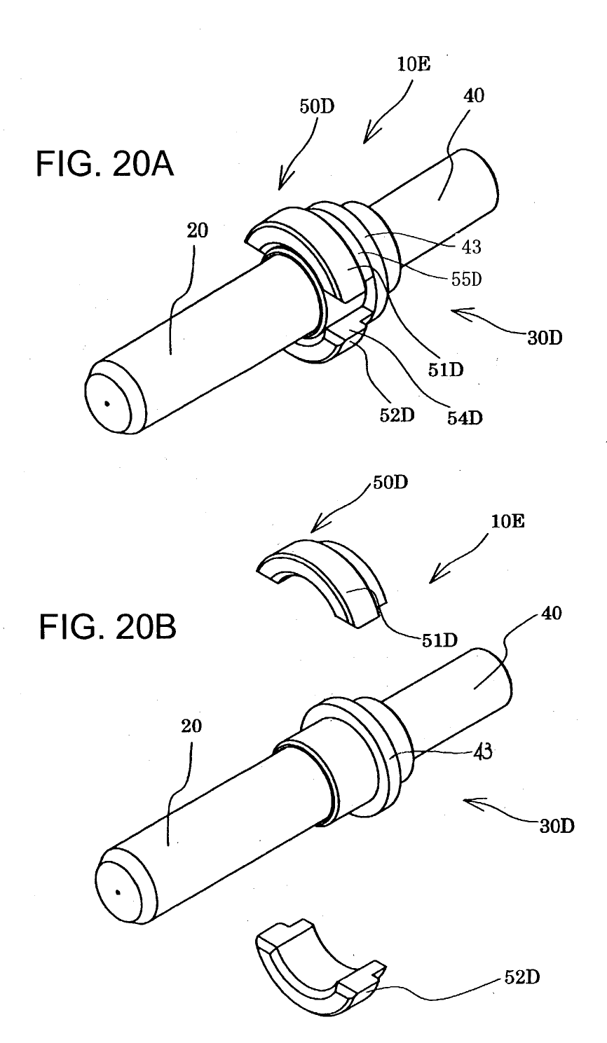

A ferrule according to another embodiment is shown in FIG. 20. FIG. 20A is a perspective view showing the ferrule, whereas FIG. 20B is a disassembled perspective view thereof.

As shown in FIGS. 20A and 20B, a ferrule 10E comprises the ferrule cylindrical body 20 and a flange member 30D, which comprises the holder portion 40 fitted on the trailing end of the ferrule cylindrical body 20, and a flange portion 50D joined to the outer periphery of the holder portion 40. The holder portion 40 is provided with the flange 43 abutting against a trailing end of the flange portion 50D thereby restricting the axially rearward movement of the flange portion 50d. The flange portion 50D consists of two split members 51D, 52D, which define a rotation positioning portion 54D between the circumferentially opposite end faces thereof in a manner to provide a predetermined clearance between the rotation positioning portion 54D and the engagement portion formed in the plug frame of the optical connector plug. The split members 51D, 52D are each formed with a step 55D at the trailing end thereof abutting against the flange 43. An outer periphery of the step 55D is flush with the outer periphery of the flange 43. The arrangement wherein the outer periphery of the flange 43 is flush with that of the step 55D provides for easy and reliable welding such as with YAG laser for securing the split members 51D, 52D to the holder portion 40.

In a ferrule according to another embodiment, the split members constituting the flange portion of the first to third embodiments may be positioned and fixed to the outer periphery of the ferrule cylindrical body at place axially rearwardly thereof. In this case, the holder portion without the flange portion may be fitted on a trailing end of the ferrule cylindrical body. Otherwise, the ferrule cylindrical body may be configured to function as the holder portion, as well. In any of these modes, the ferrule may be assembled in the optical connector plug. The fabrication method for ferrule illustrated in the first embodiment may be used to position and fix the split members to the outer periphery of the ferrule cylindrical body in a manner that the rotation positioning portion defined between the opposite end faces of the split members is placed at a predetermined position and provides a predetermined clearance relative to the engagement portion formed in the holder member of the optical connector plug. In this embodiment, as well, it is preferred that the split members are configured to define a predetermined clearance between their inner periphery except for their ends and the outer periphery of the holder portion such that the rotation positioning portion may be formed in a predetermined engagement width.

Although the foregoing first to third embodiments illustrate a SC-type optical connector plug, the invention is not limited to this. The invention is applicable to, for example, optical connector plugs of LC-type, MU-type, FC-type and the like.

Effects of the Invention

As mentioned supra, the invention is arranged such that the flange portion comprises the split members defined by circumferentially divided pieces. Hence, the assembly work of the ferrule does not require the flange portion to be previously threaded on the optical fiber. Furthermore, the invention eliminates the problem that the flange portion introduced from the leading end side may cause damage to the leading end face of the optical fiber and ferrule cylindrical body. As a result, the assembly steps are simplified.

When the split members are fixed to places, the size or position of the rotation positioning portion can be readily defined with high precision. Thus, the axial rotational movement of the ferrule assembled in the optical connector plug may be restricted within a predetermined range.

1. A ferrule comprising:
a ferrule cylindrical body for retaining an end of an optical fiber; and
a flange portion shaped like a polygon or disc circumferentially projecting as provided on an outer periphery of the ferrule cylindrical body and including a rotation positioning portion for defining a position of the ferrule cylindrical body relative to a holder member of an optical connector plug, and comprising a plurality of split members each consisting of a circumferentially divided segment.

2. A ferrule comprising:
a ferrule cylindrical body for retaining an end of an optical fiber; and
a flange member including a holder portion provided at a trailing end of the ferrule cylindrical body for retaining a fiber core comprising the optical fiber and a cladding over an outer periphery of the optical fiber, and a flange portion shaped like a polygon or disc circumferentially projecting as provided on an outer periphery of the holder portion, and including a rotation positioning portion for defining a position of the ferrule cylindrical body relative to a holder member of an optical connector plug, and comprising a plurality of split members each consisting of a circumferentially divided segment.

3. A ferrule as claimed in claim 1, wherein the flange portion has a disc-like shape and including a predetermined clearance between circumferentially opposite end faces of the split members, and wherein the rotation positioning portion comprises a key groove defined between the circumferentially opposite end faces of the split members.

4. A ferrule as claimed in claim 1, wherein the rotation positioning portion comprises an outer periphery of the flange portion.

5. A ferrule as claimed in claim 1 wherein a predetermined clearance is formed between an inner periphery of the split member exclusive of its circumferential ends and an outer periphery of the holder portion or ferrule cylindrical body.

6. A ferrule as claimed in claim 2, wherein the outer periphery of the holder portion comprises a first tapered surface whereas an inside surface of the split member, constituting the flange portion, comprises a second tapered surface slidably contacting the first tapered surface.

7. A ferrule as claimed in claim 6, wherein the first tapered surface comprises the outer periphery of the holder portion progressively decreased in outside diameter toward the leading end side, whereas the second tapered surface comprises the inside surface of the split member, constituting the flange portion, progressively decreased in inside diameter toward the leading end side.

8. A ferrule as claimed in claim 2, wherein the holder portion is provided with a flange on the outer periphery thereof, the flange radially projecting and engaging the flange portion for restricting an axial movement thereof.

9. A ferrule as claimed in claim 1, wherein the optical fiber is a polarization-maintaining optical fiber.

10. A ferrule as claimed in claim 1, wherein a leading end face of the ferrule cylindrical body and optical fiber is in the form of an obliquely projected face relative to a plane orthogonal to an axis of the optical fiber.

11. An optical connector plug comprising a ferrule as claimed in claim 1, and a holder member for retaining the ferrule.

12. An optical connector plug as claimed in claim 11, wherein the rotation positioning portion for the ferrule is disposed at an axial leading end of the flange portion, and wherein the holder member includes therein an engagement portion formed in a predetermined engagement width along the axial direction of the optical fiber, thereby providing a predetermined clearance between the rotation positioning portion and the engagement portion.

13. An optical connector plug as claimed in claim 12, wherein the rotation positioning portion of the flange portion comprises the key groove defined between the circumferentially opposite end faces of the split members, whereas the engagement portion comprises an engaging projection projecting into the key groove.

14. An optical connector plug as claimed in claim 12, wherein the rotation positioning portion of the flange portion comprises the outer periphery of the flange portion, whereas the engagement portion is an engagement hole comprising a through hole extended axially.

15. A fabrication method for ferrule including a ferrule cylindrical body for retaining an end of an optical fiber, and a flange portion shaped like a polygon or disc circumferentially projecting as provided on an outer periphery of the ferrule cylindrical body, including a rotation positioning portion for defining a position of the ferrule cylindrical body relative to a holder member of an optical connector plug, and comprising a plurality of split members each consisting of a circumferentially divided segment, the method comprising the steps of:
inserting the optical fiber and a fiber core into the ferrule cylindrical body thereby fixing the fiber and core therein; and
positioning and fixing the split members to the outer periphery of the ferrule cylindrical body in a manner that the rotation positioning portion is set at a predetermined position as providing a predetermined clearance relative to an engagement portion formed in the holder member.

16. A fabrication method for ferrule including a ferrule cylindrical body for retaining an end of an optical fiber, and a flange member including a holder portion disposed at a trailing end of the ferrule cylindrical body for retaining a fiber core including the optical fiber and a cladding over an outer periphery of the optical fiber, and a flange portion shaped like a polygon or disc circumferentially projecting as provided on an outer periphery of the ferrule cylindrical body, including a rotation positioning portion for defining a position of the ferrule cylindrical body relative to a holder member of an optical connector plug, and comprising a plurality of split members each consisting of a circumferentially divided segment, the method comprising the steps of:
mounting the holder portion to a trailing end of the ferrule cylindrical body, inserting the optical fiber and fiber core into the ferrule cylindrical body and holder portion thereby fixing the fiber and core therein; and
positioning and fixing the split members to the outer periphery of the holder portion in a manner that the rotation positioning portion is set at a predetermined position as providing a predetermined clearance relative to an engagement portion formed in the holder member.

17. A fabrication method for ferrule as claimed in claim 16, wherein the optical fiber is a polarization-maintaining optical fiber, wherein the step of fixing the polarization-maintaining optical fiber in the ferrule cylindrical body is followed by a step of polishing an end face of the ferrule cylindrical body and optical fiber, and wherein in the step of positioning and fixing the split members to the outer periphery of the holder portion, a direction of a polarization plane of the optical fiber is observingly determined and the split members are positioned and fixed to the outer periphery of the holder portion in a manner to establish a predetermined positional relation between the rotation positioning portion and the polarization plane.

18. A fabrication method for ferrule as claimed in claim 16, further comprising a step following the step of positioning and fixing the split members to the outer periphery of the holder portion and performed for polishing a leading end face of the ferrule cylindrical body and optical fiber with reference to the position of the rotation positioning portion thereby forming an obliquely projected face relative to a plane orthogonal to an axis of the optical fiber.

19. A fabrication method for ferrule as claimed in claim 16, wherein the split members define a predetermined clearance between circumferentially opposite end faces thereof, wherein the rotation positioning portion comprises a key groove defined between the circumferentially opposite end faces of the split members, and wherein the step of positioning and fixing the split members to predetermined positions is performed using a jig including an engaging projection of a configuration equivalent to that of the engagement portion formed in the holder member.

20. A fabrication method for ferrule as claimed in claim 16, wherein the rotation positioning portion comprises the outer periphery of the flange portion, and wherein the step of positioning and fixing the split members to the outer periphery of the holder portion is performed using a jig formed with an engagement hole of a configuration equivalent to that of the engagement portion formed in the holder member.

21. A fabrication method for ferrule as claimed in claim 16, wherein the outer periphery of the holder portion comprises a tapered surface progressively decreased in outside diameter toward the leading end side whereas an inside surface of the split member, constituting the flange portion, comprises a tapered surface progressively decreased in inside diameter toward the leading end side, and wherein in the step of positioning and fixing the split members to the outer periphery of the holder portion, the holder portion is pressed into place toward the leading end side and then fixed to place.
